(19) United States
(12) Patent Application Publication
(10) Pub. No.: US 2006/0230102 A1
(43) Pub. Date: Oct. 12, 2006

(54) Automated training program generation and distribution system

(76) Inventor: Murray Hidary, New York, NY (US)

Correspondence Address: GOTTLIEB RACKMAN & REISMAN PC, 270 MADISON AVENUE, 8TH FLOOR, NEW YORK, NY, 100160601, US

(21) Appl. No.: 11/090,541

(22) Filed: Mar. 25, 2005

(51) Int. Cl. G06F 15/16

(52) U.S. Cl. 709/203

(57) ABSTRACT

A system for generating and distributing training programs includes a program server, a library of program sections and templates and a program generator. A participant sends a request for a program that is matched to one of the templates. The template is then used by the program generator to assemble a set of program sessions in a predetermined order. The program is sent to the participant. The template selection is based on patient specific data.

### PREVIOUS APPLICATIONS

None

### BACKGROUND OF THE INVENTION

A. Field of Invention

This invention pertains to a system for providing training sessions that are automatically custom-tailored for the needs and requirements of specific customers or participants. The training sessions may be used for exercising, dieting or other endeavors requiring repetitive activities.

B. Description of the Prior Art

Many endeavors require repetitive activities by the participants conducted in specific sequences for specific lengths of time. Endeavors of this kind include exercising, meditation, singing, playing of musical instruments, language studies, etc. Importantly, for best results, the sequence of acts for each endeavor should be customized for each participant, based on the participant's level of skill, physical strength, ability, mental attitude and so on. Traditionally, these endeavors were conducted under the direct supervision of a competent trainer, coach, teacher, etc. However, while such personal attention may be effective, it is also time-consuming for the supervising person and expensive for the participant. Moreover, one-to-one supervision requires that the supervising person and the participant to match their schedules both in time and space.

One solution that has been used to resolve some of these problems is to provide a class environment, with one or two supervising persons overseeing several participants or students. Of course, this approach is disadvantageous because, generally, not all the attendants in the classroom have the same level of skill, competence, or experience and therefore the level of teaching or training must be either generic to the whole group or must be at the level of the attendant with the lowest level of skill, experience or competence. In other words, it is relatively difficult to provide effective training in a classroom because the attendants cannot get a uniform level of personalized attention.

Other training vehicles have been used for directing participants in various endeavors. One such vehicle that is popular is a prerecorded mass-produced audio or video tape. These tapes contain oral and/or visual instructions from a trainer to be followed by a participant. The participant can use the tape any time as often as he or she wants. Moreover, he can stop the tape at any place, rewind it, forward it and thus listen (and view) the instructions at any place. Of course, the disadvantage of the tape is that it is generic and not customized to the needs and requirements of the participant.

In the present invention, a method and apparatus is presented that overcomes the disadvantage of the prior art. For the sake of clarity, the invention describes the generation and distribution of training programs for exercises, it being understood that programs for other endeavors may be generated and distributed in a similar manner.

### SUMMARY OF THE INVENTION

According to this invention, a method of distributing training programs includes the steps of generating a library of program sections and a plurality of templates, each template defining a sequence of program sections; receiving a request from a participant; selecting one of the templates in response to said request; generating a program by assembling the program sections using the selected template; and sending said program to the participant. Preferably, the library includes templates from more than one trainer. As part of the method, the participant provides patient-specific or personal data and the step of selecting the template is performed using said personal data. The personal data may include the level of skill of the participant, the type of exercising devices that he owns, or has access to, his physical health, list of injuries, types of exercises that he likes or dislikes, his level of competence, and so on.

If injuries are indicated, the program generator selects a template that insures that the exercises selected do not aggravate the injury. In one embodiment, the exercises are selected to provide physical therapy to the body organs or body portions affected by the injury.

Some endeavors are performed more efficiently if the participant listens to music. For these endeavors, a library of musical clips is provided. When a participant signs on, or registers, he also indicates his preferred musical genre. The program generator then adds a musical clip to the program selected from the preferred musical genre.

In one embodiment, the program generator attaches at least one of a lead-in and a lead-out segment to a program section.

If a request from a participant does not match of the templates from the library, the request, together with a participant profile (if applicable) is sent to one of the trainers. The trainer (which may be selected by the participant) then generates a special template, that may include either existing program sections, or at least one new program section. The new program section is either defined by the trainer, or is generated automatically by the system by modifying one of the existing program section (for example, by changing its length).

### BRIEF DESCRIPTION OF THE DRAWINGS

FIG. 1 shows a block diagram of a program generation and distribution SYSTEM constructed in accordance with this invention;

FIG. 2 shows a block diagram of the general operation of the system of FIG. 1;

FIG. 3 shows a plurality of program portions generated by a trainer;

FIGS. 4A and 4B show two sets of program segments for two respective programs by the trainer;

FIG. 5 shows the temporal arrangement for the program sections of the first program;

FIG. 5A shows a flow chart for the process used to generate a trainer program;

FIG. 6 shows the components of the first program; and

FIG. 7 shows a block diagram of a program generator for the system of FIG. 1.

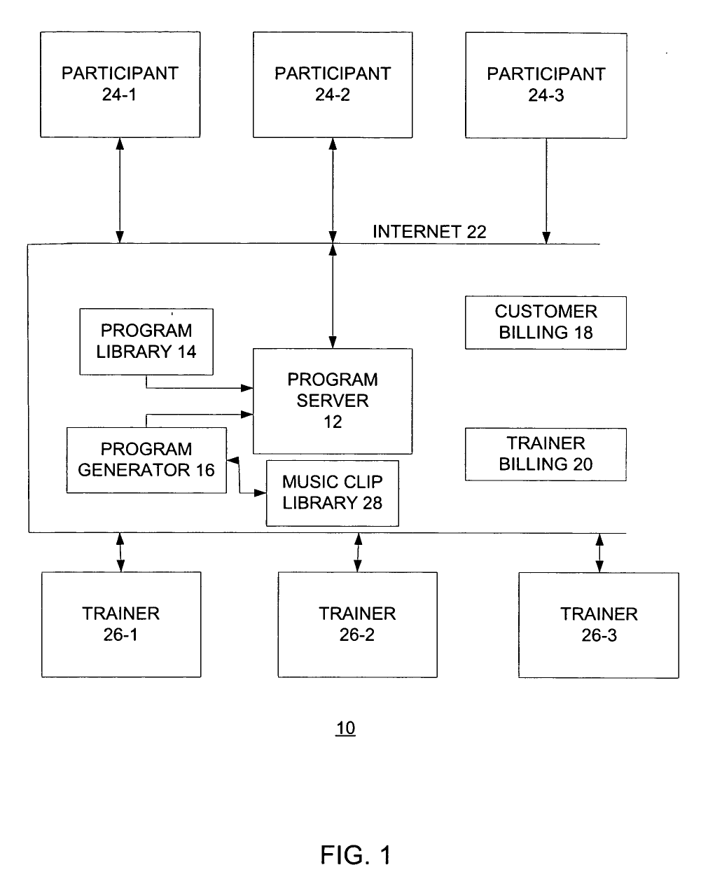

### DETAILED DESCRIPTION OF THE INVENTION

Referring now to the Figures, a system 10 constructed in accordance with this invention includes a program server 12 coupled to a program portion library 14 and a program generator 16. Optionally, a customer billing server 18 and/or a trainer billing server 20 is also provided.

The program server communicates with the outside world through Internet 22 or other means. The Internet provides a communication path to various participants 24-1, 24-2, 24-3 and a plurality of trainers 26-1, 26-2, 26-3. The system also includes a music clip library 28 with a plurality of music clips. As described in more detail below, the system 10 is used to generate training programs for different endeavors based on programming templates from various trainers. The programs preferably also include music clips as well as training content.

The customer billing server 18 is used to generate bills for the participant, while the trainer billing server 20 credits trainers for programs sold based on their templates.

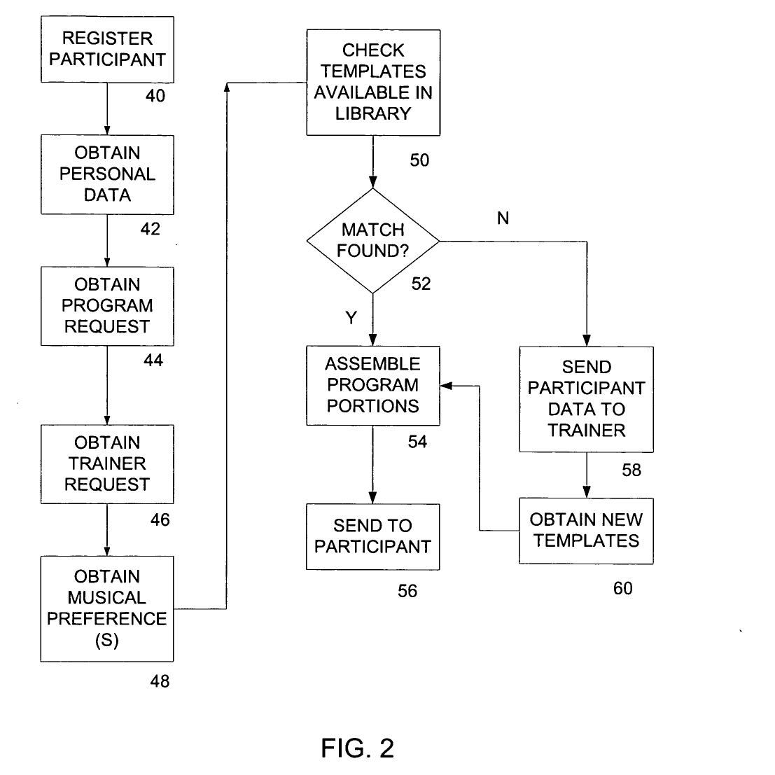

Referring now to FIG. 2, the system 10 is operated as follows. In step 40 a participant is registered. During this step, information is collected from the participant that identifies the participant by name and address. In step 42 other personal data is obtained, including factors that have an effect on the type of training program for the particular participant. For a physical training program, these factors may include sex, weight, height, level of experience, health, recent injuries, etc. Other information may be requested as well. For example, the participant may provide a list of the exercising machines and/or other equipment that she may have available. Different factors are used for other types of training programs.

In step 44 the participant selects the type of program from a variety of training programs made available by the system. For example, the system may provide training programs related to yoga, Pilates, cardiac training and endurance, weight control, weight lifting, muscle building, etc.

Other systems dedicated to other areas may provide training in several dedicated areas such as language training, recital, musical performance, and so on. Alternatively, systems may be provided that generate and distribute training programs related to several different areas.

In step 46 the participant may designate a specific trainer. For this purpose, the participant may be provided with various information about each of the trainers (for example, 26-1, 26-2, 26-3) who provide programming for the type of program selected in step 44. Next, in step 48 the musical preference(s) of the participant are obtained (i.e., whether the participant wants to exercise to R&B, classical, classical rock, or other musical genre). This step is especially suited for endeavors where background music may be helpful, such as exercise, meditation and similar endeavors, and may be omitted for other endeavors.

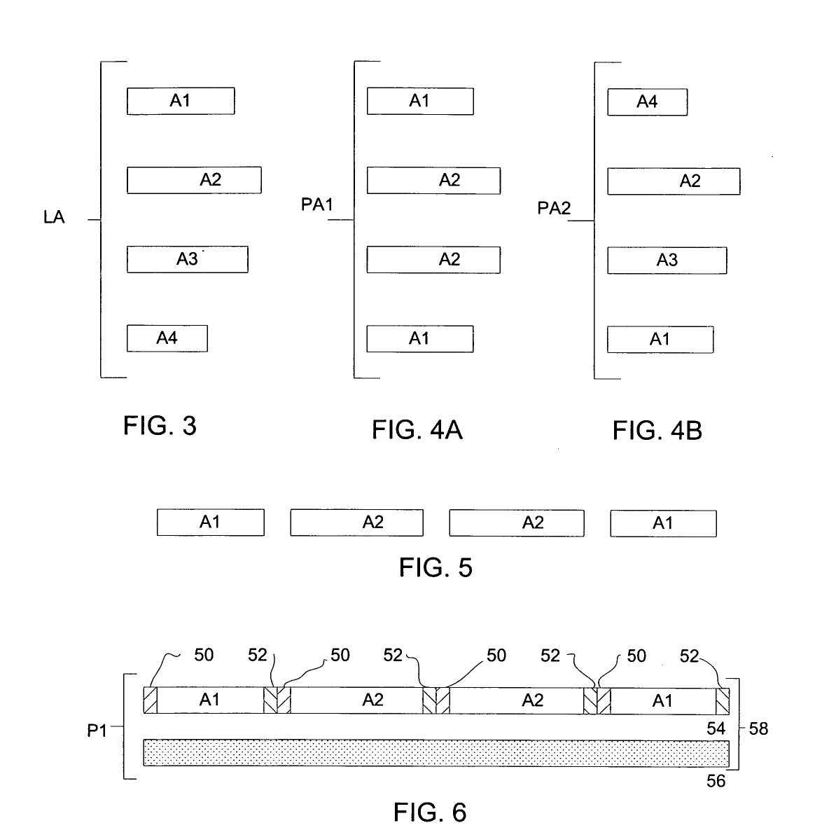

Referring now to FIGS. 3 and 4, initially, various program sections are authored and uploaded by each trainer. For example, trainer 26-1 can set up a program library L1 consisting of four portions A1-A4. These various portions may require a different exercise and/or the use of a different exercising machine. Each of the trainers 26-1, 26-2, 26-3 may generate and upload various other exercising portions for different training exercises, different participants, etc. All the program portions are stored in the library 14. In addition, the program library is also used to store various program templates that designate the sequence or order in which program portions may be played. For example, FIG. 4A shows a first template PA1 in which four program segments A1, A2, A2, A1 are arranged for a particular training program. FIG. 4B shows another template PA2 with defines a training program consisting of portions A4, A2, A3, A1, in that order. Each of the templates is associated with or designed by the trainer 26-1 for participants having certain predetermined characteristics defining a respective participant profile, and including patient-specific information. Similar templates are designated for various other participants by each of the trainers.

Returning to the flow chart of FIG. 2, once all the information is collected from the participant 24-1, in step 50 the templates stored in the program library 14 are compared to the program requested by the participant. As part of this step, the data obtained is used to insure that the selected program is compatible with the requirements of the participant. One of the criteria that may be used during selection is to insure that the selected program is safe for the participant. For example, if the participant indicates that he has suffered an injury recently to a limb or a muscle, then the selected program does not include any exercise that puts undue burden on the affected area. Alternatively, a program is selected to puts emphasis on the affected area as a means of providing therapy.

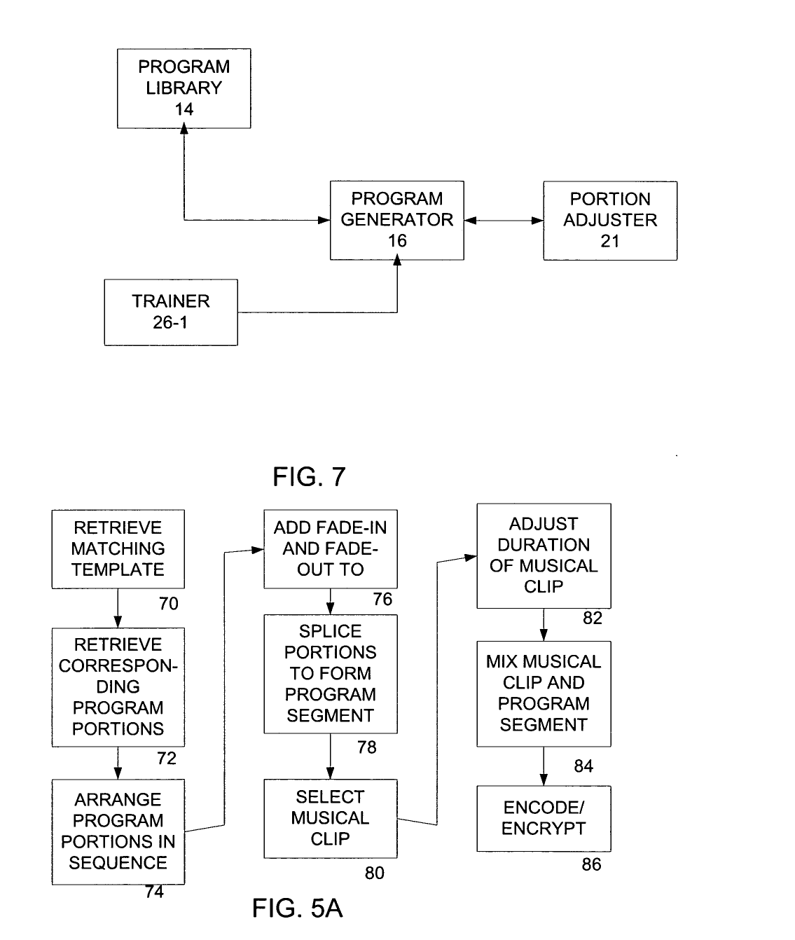

If a match is found (step 52) then in step 54 the program generator 16 assembles the requested trainer program. This process includes several steps and is shown in FIG. 5A. First, in step 70 the program generator retrieves the matching template. For example, the matching template may be PA1. Next, in step 72 the program generator 16 retrieves from the library 14 the program portions listed by the template and arranges them in the required order (step 74). Thus, template PA1 requires program portions A1 and A2 arranged in the sequence shown in FIG. 5. Next, the program generator adds to each program portion a fade-in clip 50 and a fade-out clip 52 (step 76). These clips are selected to ease the transition from one program portion to the next. Alternatively, the program portions may be stored in the library 14 with the fade-in and/or fade-out clips so that this step may be omitted.

Next, the program generator 16 splices all these components into a single program segment 54 shown in FIG. 6 (step 78). It should be emphasized that this step is performed automatically.

As discussed above, during registration, the participant is requested to select a music genre that he likes during exercise. The program generator 16 then selects from the music library 28 an appropriate clip 56. The clip 56 has to have a length or duration equal to the program segment 54. If necessary, the program selector 16 selects a clip from the music library (step 80) and adjusts its length to the required value (step 82). For example, if a selected clip is too short, it can be lengthened by repeating a section of the clip. If it is too short, the clip is cut or compressed. Next, the program segment 54 and the clip 56 are compressed to form a composite program 58 (step 84). During mixing, the relative volumes of the program segment 54 and the music clip 56 are adjusted to insure that one does not overwhelm the other. Finally, in step 86 the composite program 58 is encoded into a predetermined format (for example. MPEG-3). In the same step, the program may also be encrypted to insure that it is used only by authorized participants.

Returning to FIG. 2, once the program is generated, it is then sent to the participant 56. This may be performed in a number of ways. Preferably, the participant receives an e-mail indicating that his program is ready. The participant then signs on to a website and downloads the program into his own machine. Alternatively, the program is attached to the e-mail message to the participant.

Returning to step 52, if the requested program does not match any of the templates, then a special program is generated. For this purpose, in step 58 the data from the participant 24-1, including the participant's profile is sent the selected trainer, for example, trainer 26-1. The trainer then generates a new template and uploads it to the library 14, together with new program portions (if any) that may be necessary. Then, in step 60, the program generator obtains the new template and starts assembling the requested program in step 54, as discussed above.

In an alternate embodiment, shown in FIG. 7, trainer 26-1 sends a new template PA3 and instructions describing how new portions of the new template can be derived from the existing program portions. For example, the new template may consist of three old portions A1, A2, A4 and a modified version of portion A3. The program generator then stores the template PA3 into the library 14 and retrieves portions A1, A2, A3 and A4. It then sends portion A3 to the portion adjuster 21. The portion adjuster 21 then adjust portion A3 to generate portion A5. For example, A5 may be shortened or an extended version of portion A3. The adjuster sends portion A5 to the program generator. The program generator stores portion A5 and then uses the template PA3 to generate the special program.

As described above, each program consists of sequence of program sections. Each section consists of repetitive audio instructions covering or describing particular exercises, with background music added. Alternatively, the program sections can be video sections that provide both audio and visual instructions.

The programs can be downloaded to the participant all at once and the participant can then listen to either a portion of the program or the whole program at any time. In this manner, the participant can follow a series of programs at his own pace. For example, a program can consist of a series of lessons, each lesson consisting of one or more program sessions. The participant can play the program sessions corresponding to one lesson at any time. When he feels that he has mastered the subject matter of the lesson, he can go on to the next lesson. If he has difficulties, the participant may play the lesson over and over again until he masters it.

Preferably, each program is personalized to the abilities, requirements, preferences and other characteristics of the participants. These characteristics need not be related to the physical or athletic capabilities of the participants but to other areas as well.

The participant can run the program from his PC, or he can downloaded into a smaller player and listen to it while jogging outdoors, or on a treadmill.

In an alternate embodiment, instead of downloading the whole program, the program server can download a lesson of several program sessions at regular intervals, for example, once every two weeks, one a month, etc. The platform can be incorporated seamlessly into the websites of the third party content providers.

As discussed above, the present invention generates personalized training programs consisting of collages of audio and/or video files. Moreover, when a participant downloads a personalized training program, he can also, optionally, download a companion printout that can be used as a training manual. The printout can include text corresponding to the spoken instructions of the audio portion, as well as images selected by the training program provider. Preferably, each text, and or image is associated with one or more program portions. As the program portions are assembled and compiled, the corresponding text and images are also compiled and downloaded in a printable format with the program.

In one embodiment, the present invention is provided as a platform that can be used by third parties to provide various training programs. These third parties can be content provides who can use the service as a platform from which can be used to self-publish and maintain content for various subscribers (using, e.g. a blog-type interface).

Obviously, numerous modifications may be made to the invention without departing from its scope as defined in the appended claims.

I claim:

1. A method of distributing training programs comprising:
generating a library of program sections and a plurality of templates, each template defining a sequence of program sections;
receiving a request from a participant;
selecting one of the templates in response to said request;
generating a program by assembling the program sections using the selected template; and
sending said program to the participant.

2. The method of claim 1 wherein said library includes templates from more than one trainer.

3. The method of claim 1 further comprising receiving personal data from the participant and selecting the template based on said personal data.

4. The method of claim 3 wherein personal data is received indicating an injury, further comprising selecting a program template based on said injury.

5. The method of claim 1 further comprising selecting a musical clip and incorporating said musical clip into the program.

6. The method of claim 5 further comprising receiving from the participant a preferred music genre, wherein said musical clip is selected based on said preferred music genre.

7. A system of distributing training programs comprising:
a program generator;
a program library storing a plurality of program sections and templates defining sequences of program sections, each program section defining a plurality of training steps associated with a particular endeavor; and
a program server that receives request from a participant, and in response transmits a program from the program generator, said program including program sections sequenced by a template corresponding to said request.

8. The system of claim 7 further comprising musical clips, said program including one of said musical clips.

9. The system of claim 8 wherein said selected musical clip matches a preference of the participant.

10. The system of claim 7 wherein said program server receives and stores templates from a plurality of trainers.

11. The system of claim 7 further comprising a billing server generating charges to the participant for the program.

12. The system of claim 7 wherein different templates originate from different trainers, further comprising a billing server that calculates amounts owed to the trainers based on requests from participants.

13. The system of claim 7 wherein the program generator attaches at least one of a lead-in and a lead-out segment to a program section.

14. The system of claim 13 wherein the program generator attaches a lead-in and a lead-out segment to each program section.

15. The system of claim 7 wherein the program generator adds a musical clip to the selected program sections.

16. The system of claim 15 wherein said program generator equalizes the amplitude of said clip and said selected program sections.

17. The system of claim 7 further comprising a plurality of text sections and images, each text section and image being associated with at least one program section, wherein said program generator compiles text sections and images corresponding to the selected program sections and defines a downloadable companion printout.
